(19) United States
(12) Patent Application Publication
(10) Pub. No.: US 2011/0065911 A1
(43) Pub. Date: Mar. 17, 2011

(54) METHOD FOR PRODUCING A BIOACTIVE GLUCAN PRODUCT SUBSTANTIALLY FREE OF ENDOTOXIN CONTAMINATION

(75) Inventor: Reinhard Koenig, Rockville, MD (US)

(73) Assignee: NOVOGEN RESEARCH PTY LTD, North Ryde, New South Wales (AU)

(21) Appl. No.: 12/918,191

(22) PCT Filed: Feb. 19, 2009
(86) PCT No.: PCT/AU2009/000185

§ 371 Date: Nov. 22, 2010

Related U.S. Application Data
(60) Provisional application No. 61/029,739, filed on Feb. 19, 2008.

(51) Int. Cl. C08B 37/00

(52) U.S. Cl. 536/123.12

(57) ABSTRACT

The present invention relates to a method for producing a glucan product substantially free of endotoxin contamination.

### TECHNICAL FIELD

The present invention relates to methods for producing bioactive glucan products that are substantially free of endotoxins.

### BACKGROUND OF THE INVENTION

Glucans are polysaccharide molecules consisting of glucose subunits. Beta-glucan is a potent stimulator of the immune system because of its ability to enhance the effect of macrophages. Beta-glucan may also moderate glycaemic response, assist in wound healing, lower serum cholesterol levels and possess anti-tumour activity. In light of the utility of beta-glucan in particular, therapeutic compositions comprising glucans have been commercially available for a number of years.

Beta-glucans occur in a variety of organisms including microorganisms, basidiomycetes and plants, and are typically located in the cell walls of such organisms. Beta-glucan is therefore usually isolated from the environment in which it naturally occurs, and subsequently included in therapeutic or health supplemental compositions.

An example of the isolation of glucan from a natural source can be found in U.S. Pat. No. 6,242,594, which discloses a process for isolating a microparticulate beta-glucan from a naturally occurring glucan source by a series of extraction steps. The particular glucan obtained from this process (poly-(1,3)-beta-D-glucopyranosyl-(1,6)-beta-D-glucopyranose) has been found to be therapeutically effective when administered, for example, to subjects suffering from a bone fracture, ulcers caused by physical trauma, impaired blood flow, infections or neoplasia, or in persons in need of enhancement of fixation of implanted orthopaedic devices to bone. It is thought that poly-(1,3)-beta-D-glucopyranosyl-(1,6)-beta-D-glucopyranose may modulate the natural cascade of wound healing activities of several cell populations when applied directly to a wound surface. Such cell populations include macrophages, fibroblasts, vascular endothelial cells, epithelial cells and neutrophils.

Because compositions comprising glucans are administered to humans and animals, it is vital that the constituent glucan is free from potentially harmful contaminants and byproducts. Indeed, therapeutic compositions for in vivo administration to humans are required to meet stringent regulatory authority (e.g. FDA) requirements.

Potential contaminants that may be present in extracted glucan preparations include endotoxins. Endotoxins are the lipopolysaccharide (LPS) component of the cell wall of all forms of Gram negative bacteria. Small amounts of endotoxin can cause illness in humans, and therapeutic preparations should have as low a burden as possible.

The present inventor has determined that endotoxin levels in glucan extracted from a natural source can essentially be reduced below detection limits by employing certain process steps.

### SUMMARY OF THE INVENTION

In a first aspect, the present invention provides a method for producing a glucan product substantially free of endotoxin contamination, said method comprising the step of washing the glucan with a halogentated solvent.

The halogenated solvent may be a halogenated solvent having a greater specific weight than water, for example chloroform.

The method may further comprise washing the glucan with an alcoholic solvent.

The alcoholic solvent may be selected from methanol, ethanol, propanol, butanol, pentanol etc, and mixtures thereof.

The glucan may be washed with the halogenated solvent and/or the alcoholic solvent multiple times.

The glucan may be dried, for example spray dried, prior to being washed with the halogenated solvent.

The glucan may be washed with the alcoholic solvent at neutral pH, basic pH or acidic pH, or any combination thereof. In one embodiment, the method may comprise washing the glucan with the alcoholic solvent at neutral pH, basic pH and acidic pH.

The method may further comprise washing the glucan with a solution of a mineral acid, for example phosphoric acid.

The method may further comprise exposing the glucan to basic conditions.

The basic conditions may be a pH of between about 10 and about 14.

The method may further comprise washing the glucan with water.

The method may further comprise subjecting the glucan to dry heat sterilization.

In a second aspect, the present invention provides a method for producing a glucan product substantially free of endotoxin contamination, said method comprising the step of exposing the glucan to basic conditions.

The basic conditions may be a pH of between about 10 and about 14.

The method may further comprise washing the glucan with a halogenated solvent.

The halogenated solvent may be chloroform.

The method may further comprise washing the glucan with an alcoholic solvent.

The alcoholic solvent may be ethanol.

The glucan may be washed with the halogenated solvent and/or the alcoholic solvent multiple times.

The glucan may be dried, for example spray dried, prior to being washed with the halogenated solvent.

The glucan may be washed with the alcoholic solvent at neutral pH, basic pH or acidic pH, or any combination thereof. In one embodiment, the method may comprise washing the glucan with the alcoholic solvent at neutral pH, basic pH and acidic pH.

The method may further comprise washing the glucan with a solution of a mineral acid, for example phosphoric acid.

The method may further comprise washing the glucan with water.

The method may further comprise subjecting the glucan to dry heat sterilization.

The glucan may be soluble, insoluble, particulate or microparticulate glucan. In one embodiment, the glucan is a microparticulate glucan.

The glucan may be beta-glucan.

The glucan may be beta-(1,3)(1,6)glucan.

The glucan may be a particulate branched beta-(1,3)(1,6)glucan that is essentially free of unbranched beta-(1,3)glucan.

The glucan may be microparticulate poly-(1,3)-beta-D-glucopyranosyl-(1,6)-beta-D-glucopyranose.

The glucan may be obtained from a cellular glucan source.

The cellular glucan source may be a microorganism.

The microorganism may be Saccharomyces cerevisiae.

The dry heat sterilization may involve subjecting the glucan to a temperature of between about 140° C. and about 180° C. for a period of between about 20 minutes and about 12 hours, or between about 1 hour and about 10 hours. In one embodiment, the dry heat sterilization may be performed at a temperature of about 160° C. for a period of about 2 to 4 hours.

The dry heat sterilization may be performed at atmospheric pressure.

The dry heat sterilization may be performed under positive pressure.

The dry heat sterilization may be performed in an oven.

The oven may be an oven that is able to circulate air, for example a convection oven such as a fan forced oven.

In a third aspect, the present invention provides a method for producing a glucan product substantially free of endotoxin contamination, said method comprising the following steps:

(i) exposing the glucan to basic conditions; and

(ii) washing the glucan with a chlorinated solvent.

In a fourth aspect, the present invention provides a method for producing a glucan product substantially free of endotoxin contamination, said method comprising the following steps:

(i) exposing the glucan to basic conditions;

(ii) washing the glucan with a chlorinated solvent; and

(iii) washing the glucan with an alcoholic solvent.

The following applies to the third and fourth aspects:

The basic conditions may be a pH of between about 10 and 14.

The chlorinated solvent may be chloroform.

The glucan may be dried prior to being washed with the chlorinated solvent.

The alcoholic solvent may be ethanol.

The method may further comprise washing the glucan with a solution of a mineral acid.

In a fifth aspect, the present invention provides a method for producing a glucan product substantially free of endotoxin contamination, said method comprising the following steps:

(i) washing the glucan with a chlorinated solvent; and

(ii) subjecting the glucan to dry heat sterilization.

The method may further comprise exposing the glucan to basic conditions.

In a sixth aspect, the present invention provides a method for producing a glucan product substantially free of endotoxin contamination, said method comprising the following steps:

(i) exposing the glucan to basic conditions; and

(ii) subjecting the glucan to dry heat sterilization.

The following applies to the fifth and sixth aspects:

The basic conditions may be a pH of between about 10 and 14.

The chlorinated solvent may be chloroform.

The glucan may be dried prior to being washed with the chlorinated solvent.

The dry heat sterilization may be carried out at a temperature between about 140° C. and about 180° C. for a period of between about 20 minutes and about 12 hours.

The methods may further comprise washing the glucan with an alcoholic solvent.

The method may further comprise washing the glucan with a solution of a mineral acid.

In a seventh aspect, the present invention provides a method for producing a glucan product substantially free of endotoxin contamination, said method comprising the following steps:

(i) exposing the glucan to basic conditions;

(ii) washing the glucan with an alcoholic solvent; and

(iii) subjecting the glucan to dry heat sterilization.

In an eighth aspect, the present invention provides a method for producing a glucan product substantially free of endotoxin contamination, said method comprising the following steps:

(i) exposing the glucan to basic conditions;

(ii) washing the glucan with a chlorinated solvent; and

(iii) subjecting the glucan to dry heat sterilization.

The following applies to the seventh and eighth aspects:

Step (iii) may be performed as the final step in the methods.

The basic conditions may be a pH of between about 10 and 14.

The chlorinated solvent may be chloroform.

The glucan may be washed with the alcoholic solvent at neutral pH, basic pH or acidic pH, or any combination thereof. In one embodiment, the method may comprise washing the glucan with the alcoholic solvent at neutral pH, basic pH and acidic pH.

The glucan may be dried prior to being washed with the chlorinated solvent.

The dry heat sterilization may be carried out at a temperature between about 140° C. and about 180° C. for a period of between about 20 minutes and about 12 hours.

The method may further comprise washing the glucan with a solution of a mineral acid.

In a ninth aspect, the present invention provides a method for producing a glucan product substantially free of endotoxin contamination, said method comprising the following steps:

(i) washing the glucan with an alcoholic solvent; and

(ii) subjecting the glucan to dry heat sterilization.

The dry heat sterilization may be carried out at a temperature between about 140° C. and about 180° C. for a period of between about 20 minutes and about 12 hours.

The method may further comprise washing the glucan with a solution of a mineral acid.

In a tenth aspect, the present invention provides a method for producing a glucan product substantially free of endotoxin contamination, said method comprising the following steps:

(i) washing the glucan with an alcoholic solvent;

(ii) washing the glucan with a chlorinated solvent; and

(iii) subjecting the glucan to dry heat sterilization.

In an eleventh aspect, the present invention provides a method for producing a glucan product substantially free of endotoxin contamination, said method comprising the following steps:

(i) exposing the glucan to basic conditions;

(ii) washing the glucan with an alcoholic solvent;

(iii) washing the glucan with a chlorinated solvent; and

(iv) subjecting the glucan to dry heat sterilization.

The following applies to the tenth and eleventh aspects.

The alcoholic solvent may be ethanol

The glucan may be washed with the halogenated solvent and/or the alcoholic solvent multiple times.

The glucan may be dried, for example spray dried, prior to being washed with the halogenated solvent.

The glucan may be washed with the alcoholic solvent at neutral pH, basic pH or acidic pH, or any combination thereof. In one embodiment, the method may comprise washing the glucan with the alcoholic solvent at neutral pH, basic pH and acidic pH.

The method may further comprise washing the glucan with a solution of a mineral acid, for example phosphoric acid.

The basic conditions may be a pH of between about 10 and about 14.

The method may further comprise washing the glucan with water.

The dry heat sterilization may be carried out at a temperature between about 140° C. and about 180° C. for a period of between about 20 minutes and about 12 hours.

Step (iv) may be performed as the final step in the methods.

In the methods of the first to eleventh aspects, the recited steps may be carried out in the stated order or in any other order.

In a twelfth aspect, the present invention provides glucan that is substantially free of endotoxin contamination, whenever obtained by the process of the first to eleventh aspects.

In a thirteenth aspect, the present invention provides a composition comprising the glucan of the twelfth aspect which is a therapeutic or health supplementary composition.

In a fourteenth aspect, the present invention provides use of the glucan of the first aspect in the preparation of a therapeutic or health supplementary composition.

### BRIEF DESCRIPTION OF THE DRAWINGS

The present invention will now be described, by way of non-limiting example only, with reference to the accompanying drawings.

FIG. 1. Dose response curve of TNF-α release (pg/mL) from macrophages stimulated with varying concentrations of endotoxin (ng/mL). The negative control demonstrating an absence of TNF-α release in the absence of endotoxin is also shown.

### DEFINITIONS

In the context of this specification, the terms “a” and “an” are used herein to refer to one or to more than one (i.e. to at least one) of the grammatical object of the article. By way of example, “an element” means one element or more than one element.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

In the context of this specification, the term “glucan” is understood to mean a polysaccharide of glucose monomers linked by glycosidic bonds.

In the context of this specification, the term “substantially free of endotoxin contamination” is understood to mean a level of endotoxin that is not detectable by commercially available endotoxin tests, or not detectable by an in-vitro bioassay measuring endotoxin burden via TNF-α release.

In the context of this specification, the term “microparticulate” is understood to mean in the form of particles not more than 40 μm in size.

In the context of this specification, the term “dry heat sterilization” is understood to mean heating the glucan in an environment wherein the humidity level is less than 100%.

### DETAILED DESCRIPTION OF THE INVENTION

The present invention is based on the surprising discovery by the inventor that endotoxin levels in glucan products can be substantially removed by exposing the glucan to specific conditions. Broadly, these conditions include: basic conditions, washing with chlorinated solvents, washing with alcoholic solvents, dry heat sterilization, acidic conditions and washing with water. In some embodiments, endotoxin may be substantially removed by subjecting the glucan to a combination of one or more of the above conditions. The methods of the invention typically form part of a larger method for extracting glucan from a naturally occurring glucan source, for example a microorganism such as Saccharomyces cerevisiae. However, the methods of the invention may be performed on glucan products that have been removed from their natural state and at least partially purified.

The glucan may be soluble, insoluble, particulate or microparticulate glucan. In one embodiment, the glucan is a microparticulate glucan. The glucan may be beta-glucan, in particular beta-(1,3)(1,6)glucan. In one embodiment, the glucan is a particulate branched beta-(1,3)(1,6)glucan that is essentially free of unbranched beta-(1,3)glucan. In another embodiment, the glucan is a microparticulate poly-(1,3)-beta-D-glucopyranosyl-(1,6)-beta-D-glucopyranose.

The term “substantially free of endotoxin contamination” may mean an endotoxin contamination that is less than about 30 pg/mL of the glucan product. A glucan product may also be understood to be “substantially free of endotoxin contamination” where endotoxin in such a product is not able to be detected by the endotoxin bioassay method described in co-pending application U.S. Ser. No. 61/029,758.

The conditions to which the glucan may be subjected so as to substantially remove endotoxin are described in detail below.

Washing with Halogenated Solvents

This step may be performed by adding a chlorinated solvent to an aqueous suspension of particulate glucan. The ratio of solvent to aqueous suspension may be between about 1:10 and 1:3. The resulting mixture may be agitated by stirring for a period of between about 15 minutes and about 1 hour. The mixture may then be allowed to settle. The chloroform layer may then be separated and discarded and the liquid containing the glucan collected and treated to further washing if desired.

In alternative embodiments, the particulate glucan may be dried or semi-dried prior to being washed with the halogenated solvent. The dried or semi-dried glucan may be added to the halogenated solvent and mixing performed for about 15 minutes to 1 hour. The glucan may then be collected by filtration and optionally washed with further halogenated solvent.

### Dry Heat Sterilization

Dry heat sterilization of glucan may be performed as described in a co-pending application U.S. Ser. No. 60/984,045, the disclosure of which is incorporated herein by reference.

Washing with Alcoholic Solvents

This step may be performed by adding an alcoholic solvent to an aqueous suspension of particulate glucan. The alcoholic solvent may be anhydrous. The ratio of solvent to aqueous suspension may be between about 1:2 and 2:1. The mixture may be agitated by stirring for a period of between about 15 minutes and 1 hour, and then allowed to settle. The clear liquid layer may then be decanted and the liquid containing the glucan collected and treated to further washing if desired. The washing with the alcoholic solvent may be performed on a particulate glucan suspension having a neutral pH, an acidic pH or a basic pH.

In alternative embodiments, the particulate glucan may be dried or semi-dried prior to being washed with the alcoholic solvent. The dried or semi-dried glucan may be added to the alcoholic solvent and mixing performed for about 15 minutes to 1 hour. The glucan may then be collected by filtration and optionally washed with further alcoholic solvent.

Washing with Water

This step may be carried out by adding purified water (USP) to an aqueous suspension of particulate glucan, or alternatively by adding purified water to dried or semi-dried particulate glucan. The resultant mixture may be agitated by stirring, either under atmospheric pressure or under a vacuum. In addition, the mixture may also be heated to a temperature between about 50° C. and 90° C., or between about 60° C. and 80° C. Following agitation, the mixture may be allowed to settle. The clear liquid layer may then be decanted and the liquid containing the glucan collected and treated to further washing if desired. Alternatively, following agitation the glucan may be recovered by centrifugation.

### Acidic Conditions

This step may be carried out by adjusting the pH of an aqueous suspension of particulate glucan to between about 1 and about 6, or between about 2 and about 5, or between about 2.5 and 4.5, or between about 3 and 4, by addition of an acid, for example a mineral acid such as phosphoric acid. The resultant mixture may be agitated by stirring, either under atmospheric pressure or under vacuum. In addition, the mixture may also be heated to a temperature between about 80° C. and 115° C., or between about 90° C. and 105° C. Following cooling, the clear liquid layer may then be decanted and the liquid containing the glucan collected and treated to further washing if desired. Alternatively, following agitation the glucan may be recovered by centrifugation.

### Basic Conditions

This step may comprise adjusting the pH of an aqueous suspension of particulate glucan to between about 8 and 14.5, or between about 10 and 14.5 by addition of hydroxide (for example 2% to 6% (w/v) NaOH or KOH). The resultant mixture may then be agitated by stirring, either under atmospheric pressure or under vacuum. In addition, the mixture may also be heated to a temperature between about 90° C. and 110° C., or between about 90° C. and 105° C. Following addition of water, the mixture may be cooled and allowed to settle overnight. The clear liquid layer may then be decanted and the liquid containing the glucan collected and treated to further washing if desired.

Typically, the step of subjecting the glucan to basic conditions is carried out when the glucan is present in its naturally occurring state, for example in yeast cells, however partially purified glucan may also be subjected to basis conditions so as to assist in endotoxin removal.

### Modes for Performing the Invention

In a first aspect, the present invention relates to a method for producing a glucan product substantially free of endotoxin contamination, said method comprising the step of washing the glucan with a halogentated solvent. In this aspect, the halogenated solvent may be chloroform for example. The method may be performed as described above, and may be carried out a plurality of times. In one embodiment, the method is performed on particulate glucan that has been dried.

The method may further comprise additional steps that may assist in endotoxin removal. For example, in one embodiment, the method may comprise the following steps:
(i) washing dried glucan powder with a chlorinated solvent;
(ii) washing the product of step (i), which has been semi-dried with an alcoholic solvent;
(iii) washing the product of step (ii) with a chlorinated solvent; and
(iv) washing the product of step (iii) with an alcoholic solvent.

The alcoholic solvent may be ethanol.

The washing with the alcoholic solvent may be carried out as described above.

The method of the first aspect may also further comprise subjecting the glucan obtained in step (iv) to dry heat sterilization.

In a second aspect, the present invention relates to a method for producing a glucan product substantially free of endotoxin contamination, said method comprising the step of exposing the glucan to basic conditions. The method may be carried out as described above on a glucan present in a form in which it is found in nature, for example in yeast cells. In one embodiment, the method may be carried out on multiple occasions. For example, yeast comprising glucan may be subjected to treatment with hydroxide in a first step, the insoluble product may then be treated with further hydroxide.

The method may further comprise washing the base-treated glucan with a solution of a mineral acid, for example hydrochloric acid, phosphoric acid, nitric acid, sulphuric acid or the like.

In a third aspect, the present invention relates to a method for producing a glucan product substantially free of endotoxin contamination, said method comprising the following steps:

(i) exposing the glucan to basic conditions; and

(ii) washing the glucan with a chlorinated solvent.

Steps (i) and (ii) may be performed as described above. Step (i) may be carried out prior to step (ii). In an embodiment of the third aspect, step (i) may be performed on a glucan present in a form in which it is found in nature, for example in yeast cells. The chlorinated solvent may be chloroform. The method may further comprise washing the glucan with water, an alcoholic solvent (for example ethanol), and a solution of a mineral acid (for example phosphoric acid). These steps may be carried out between steps (i) and (ii), or after steps (i) and (ii).

In a fourth aspect, the present invention relates to a method for producing a glucan product substantially free of endotoxin contamination, said method comprising the following steps:

(i) exposing the glucan to basic conditions;

(ii) washing the glucan with a chlorinated solvent; and

(iii) washing the glucan with an alcoholic solvent.

Steps (i) to (iii) may be performed as described above. In an embodiment of the fourth aspect, step (i) may be performed on a glucan present in a form in which it is found in nature, for example in yeast cells. Step (i) may be performed prior to steps (ii) and (iii). Step (iii) may be carried out at either at neutral pH, acidic pH or basic pH. Washing at acidic pH may be carried out wherein the pH is between about 2 and about 6, or alternatively between about 3 and about 5.5, or alternatively between about 3.5 and about 5, or alternatively between about 4 and about 5. Washing at neutral pH may be carried out wherein the pH is between about 6.5 and about 7.5, or alternatively between about 6.8 and about 7.2. Washing at basic pH may be carried out wherein the pH is between about 8 and about 11, or alternatively between about 8 and about 10, or alternatively between about 8.5 and about 9.5.

In one embodiment, the method may further comprise washing the glucan with a solution of a mineral acid. Accordingly, the method of the fourth aspect may include the following steps:

(i) exposing the glucan to basic conditions;

(ii) washing the glucan with a solution of a mineral acid;

(iii) washing the glucan with an alcoholic solvent; and

(iv) washing the glucan with a chlorinated solvent.

Step (i) to (iv) may be carried out in the order stated. Step (iii) may involve washing the glucan with an alcoholic solvent at acid pH, basic pH and neutral pH. The glucan may also be washed with water between each of steps (i) to (iv).

In a fifth aspect, the present invention provides a method for producing a glucan product substantially free of endotoxin contamination, said method comprising the following steps:

(i) washing the glucan with a chlorinated solvent; and

(ii) subjecting the glucan to dry heat sterilization.

Steps (i) and (ii) may be performed as described above. The method may further comprise washing the glucan with an alcoholic solvent. The glucan may be washed with an alcoholic solvent between steps (i) and (ii), or prior to and after step (i). The glucan may be dried prior to performing step (ii).

In a sixth aspect, the present invention relates to a method for producing a glucan product substantially free of endotoxin contamination, said method comprising the following steps:

(i) exposing the glucan to basic conditions; and

(ii) subjecting the glucan to dry heat sterilization.

Steps (i) and (ii) may be performed as described above. The method may further comprise washing the glucan with an alcoholic solvent and/or a chlorinated solvent. The washings with the alcoholic solvent and the chlorinated solvent may be carried out on multiple occasions, and may be performed between steps (i) and (ii).

In a seventh aspect, the present invention relates to a method for producing a glucan product substantially free of endotoxin contamination, said method comprising the following steps:

(i) exposing the glucan to basic conditions;

(ii) washing the glucan with an alcoholic solvent; and

(iii) subjecting the glucan to dry heat sterilization.

Steps (i) to (iii) may be performed as described above. In an embodiment of the seventh aspect, step (i) may be performed on a glucan present in a form in which it is found in nature, for example in yeast cells. Steps (i) to (iii) may be carried out in the stated order. The method may further comprise washing the glucan with a solution of a mineral acid. The glucan may be washed with a solution of a mineral acid between steps (i) and (ii). Step (ii) may involve washing the glucan with an alcoholic solvent at acid pH, basic pH and neutral pH.

In an eighth aspect, the present invention relates to a method for producing a glucan product substantially free of endotoxin contamination, said method comprising the following steps:

(i) exposing the glucan to basic conditions;

(ii) washing the glucan with a chlorinated solvent; and

(iii) subjecting the glucan to dry heat sterilization.

Steps (i) to (iii) may be performed as described above. In an embodiment of the seventh aspect, step (i) may be performed on a glucan present in a form in which it is found in nature, for example in yeast cells. Steps (i) to (iii) may be carried out in the stated order. The method may further comprise washing the glucan with a solution of a mineral acid. The glucan may be washed with a solution of a mineral acid between steps (i) and (ii). The method may further comprise washing the glucan with an alcoholic solvent. The glucan may be washed with an alcoholic solvent between steps (ii) and (iii). The glucan may be dried prior to performing step (iii).

In a ninth aspect, the present invention relates to a method for producing a glucan product substantially free of endotoxin contamination, said method comprising the following steps:

(i) washing the glucan with an alcoholic solvent; and

(ii) subjecting the glucan to dry heat sterilization.

Steps (i) and (ii) may be performed as described above. The method may further comprise washing the glucan with a chlorinated solvent. The glucan may be washed with an alcoholic solvent prior to step (i). The glucan may be dried prior to performing step (ii).

In a tenth aspect, the present invention relates to a method for producing a glucan product substantially free of endotoxin contamination, said method comprising the following steps:

(i) washing the glucan with an alcoholic solvent;

(ii) washing the glucan with a chlorinated solvent; and

(iii) subjecting the glucan to dry heat sterilization.

Steps (i) and (ii) may be performed as described above. Steps (i) to (iii) may be performed in the order stated. The method may further comprise exposing the glucan to basic conditions. The glucan may be exposed to basic conditions prior to step (i). The glucan may be dried prior to performing step (iii). The glucan may be washed with the alcoholic solvent at neutral pH, basic pH or acidic pH, or any combination thereof. In one embodiment, the method may comprise washing the glucan with the alcoholic solvent at neutral pH, basic pH and acidic pH. The glucan may be washed with the halogenated solvent and/or the alcoholic solvent multiple times.

In an eleventh aspect, the present invention relates to a method for producing a glucan product substantially free of endotoxin contamination, said method comprising the following steps:

(i) exposing the glucan to basic conditions;

(ii) washing the glucan with an alcoholic solvent;

(iii) washing the glucan with a chlorinated solvent; and

(iv) subjecting the glucan to dry heat sterilization.

Steps (i) and (ii) may be performed as described above. Steps (i) to (iv) may be performed in the order stated. The glucan may be washed with the halogenated solvent and/or the alcoholic solvent multiple times. The method may further comprise washing the glucan with a solution of a mineral acid. The glucan may be washed with a solution of a mineral acid between steps (i) and (ii). In one embodiment, the method may comprise washing the glucan with the alcoholic solvent at neutral pH, basic pH and acidic pH. The method may further comprise washing the glucan with water. The glucan may be dried, for example spray dried, prior to performing step (iv).

The present invention also relates to compositions comprising glucan that is substantially free of endotoxin, wherein the glucan is obtained by the methods of any one of the first to twelfth aspects. When utilising the methods of the present invention it is possible to prepare a glucan substantially free of endotoxin which may be incorporated into a therapeutic or health supplementary composition. Accordingly, the present invention also relates to compositions comprising glucan that has been prepared in accordance with the method of any one of the first to twelfth aspects which are therapeutic or health supplementary compositions.

Glucan-containing compositions for therapeutic or health supplementary purposes may comprise between about 0.01% to about 30% (w/w) of glucan. The glucan may be present in the form of pharmaceutically acceptable nontoxic salts, such as acid addition salts. Illustrative of such acid addition salts are hydrochloride, hydrobromide, sulfate, phosphate, maleate, acetate, citrate, benzoate, succinate, malate, ascorbate, tartrate and the like.

Pharmaceutically acceptable carriers or diluents that may be used in therapeutic or health supplementary compositions comprising glucans include demineralised or distilled water; saline solution; vegetable based oils such as peanut oil, safflower oil, olive oil, cottonseed oil, maize oil, sesame oil, arachis oil or coconut oil; silicone oils, including polysiloxanes, such as methyl polysiloxane, phenyl polysiloxane and methylphenyl polysolpoxane; volatile silicones; mineral oils such as liquid paraffin, soft paraffin or squalane; cellulose derivatives such as methyl cellulose, ethyl cellulose, carboxymethylcellulose, sodium carboxymethylcellulose or hydroxypropylmethylcellulose; lower alkanols, for example ethanol or iso-propanol; lower aralkanols; lower polyalkylene glycols or lower alkylene glycols, for example polyethylene glycol, polypropylene glycol, ethylene glycol, propylene glycol, 1,3-butylene glycol or glycerin; fatty acid esters such as isopropyl palmitate, isopropyl myristate or ethyl oleate; polyvinylpyrridone; agar; carrageenan; gum tragacanth or gum acacia, and petroleum jelly. Typically, the carrier or carriers will form from 10% to 99% by weight of the compositions.

Topical compositions may comprise the glucan together with one or more acceptable carriers, and optionally any other therapeutic ingredients. Compositions suitable for topical administration may include liquid or semi-liquid preparations suitable for penetration through the skin to the site of where treatment is required, such as liniments, lotions, creams, ointments or pastes, and drops suitable for administration to the eye, ear or nose. Topical compositions may also comprise one or more rheology modifiers, for example thickeners such as cellulosic derivatives, polyvinyl alcohol, sodium polyacrylate, and other water-soluble macromolecules, as well as copolymeric emulsions in which monomers with acid groups have been introduced onto the main chain. In one embodiment, the rheology modifier may be a crosslinked acrylic acid based polymer sold under the trade name CARBOPOL®, for example CARBOPOL® 980 NF polymer.

Lotions according to the present invention include those suitable for application to the skin or eye. An eye lotion may comprise a sterile aqueous solution optionally containing a bactericide and may be prepared by methods similar to those described above in relation to the preparation of drops. Lotions or liniments for application to the skin may also include an agent to hasten drying and to cool the skin, such as an alcohol or acetone, and/or a moisturiser such as glycerol, or oil such as castor oil or arachis oil.

Creams, ointments or pastes according to the present invention are semi-solid compositions of the glucan for external application. They may be made by mixing the glucan in finely-divided or powdered form, alone or in solution or suspension in an aqueous or non-aqueous fluid, with a greasy or non-greasy basis. The basis may comprise hydrocarbons such as hard, soft or liquid paraffin, glycerol, beeswax, a metallic soap; a mucilage; an oil of natural origin such as almond, corn, arachis, castor or olive oil; wool fat or its derivatives, or a fatty acid such as stearic or oleic acid together with an alcohol such as propylene glycol or macrogols.

Pharmaceutical forms suitable for injectable use include sterile aqueous solutions (where water soluble) or dispersions and sterile powders for the extemporaneous preparation of sterile injectable solutions. It must be stable under the conditions of manufacture and storage and must be preserved against the contaminating action of microorganisms such as bacteria and fungi. The carrier can be a solvent or dispersion medium containing, for example, water, ethanol, polyol (for example, glycerol, propylene glycol and liquid polyethylene glycol, and the like), suitable mixtures thereof, and vegetable oils. The proper fluidity can be maintained, for example, by the use of a coating such as lecithin, by the maintenance of the required particle size in the case of dispersion and by the use of superfactants. The preventions of the action of microorganisms can be brought about by various antibacterial and antifungal agents, for example, parabens, chlorobutanol, phenol, sorbic acid, thimerosal and the like. In many cases, it will be preferable to include isotonic agents, for example, sugars or sodium chloride. Prolonged absorption of the injectable compositions can be brought about by the use in the compositions of agents delaying absorption, for example, aluminum monostearate and gelatin.

Sterile injectable solutions are prepared by incorporating the glucan in the required amount in the appropriate solvent with various of the other ingredients enumerated above, as required, followed by filtered sterilisation. Generally, dispersions are prepared by incorporating the various sterilised active ingredient into a sterile vehicle which contains the basic dispersion medium and the required other ingredients from those enumerated above. In the case of sterile powders for the preparation of sterile injectable solutions, the preferred methods of preparation are vacuum drying and the freeze-drying technique which yield a powder of the glucan plus any additional desired ingredient from previously sterile-filtered solution thereof.

When the glucans are suitably protected they may be orally administered, for example, with an inert diluent or with an assimilable edible carrier, or it may be enclosed in hard or soft shell gelatin capsule, or it may be compressed into tablets, or it may be incorporated directly with the food of the diet. For oral therapeutic administration, the active compound may be incorporated with excipients and used in the form of ingestible tablets, buccal tablets, troches, capsules, elixirs, suspensions, syrups, wafers, and the like. Such compositions and preparations should contain at least 1% by weight of active compound. The percentage of the compositions and preparations may, of course, be varied and may conveniently be between about 5 to about 80% of the weight of the unit. The amount of glucan in such therapeutically useful compositions in such that a suitable dosage will be obtained.

The tablets, troches, pills, capsules and the like may also contain the components as listed hereafter: a binder such as gum, acacia, corn starch or gelatin; excipients such as dicalcium phosphate; a disintegrating agent such as corn starch, potato starch, alginic acid and the like; a lubricant such as magnesium stearate; and a sweetening agent such as sucrose, lactose or saccharin may be added or a flavouring agent such as peppermint, oil of wintergreen, or cherry flavouring. When the dosage unit form is a capsule, it may contain, in addition to materials of the above type, a liquid carrier. Various other materials may be present as coatings or to otherwise modify the physical form of the dosage unit. For instance, tablets, pills, or capsules may be coated with shellac, sugar or both. A syrup or elixir may contain the active compound, sucrose as a sweetening agent, methyl and propylparabens as preservatives, a dye and flavouring such as cherry or orange flavour. Of course, any material used in preparing any dosage unit form should be pharmaceutically pure and substantially non-toxic in the amounts employed.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

The present invention will now be described with reference to the following specific examples, which should not be construed as in any way limiting the scope of the invention.

### EXAMPLES

### Example 1

### Preparation of Bioactive Glucan Substantially Free of Endotoxin

A bioactive glucan sample that is substantially free of endotoxin contamination was prepared from Saccharomyces cerevisiae using a process comprising sequential washing and extraction steps with the following: water, sodium hydroxide, phosphoric acid, chloroform and ethanol. The process further included the step of heat treatment of the glucan. The resulting glucan product obtained was a white to off-white amorphous powder having a molecular weight of about 1 million to 3 million Daltons.

Endotoxin levels in a number of glucan product samples were determined using a Pyrogene Recombinant Factor C Endotoxin Detection System (Lonza Walkersville Inc.). The samples were each found to have an endotoxin concentration of less than 0.10 EU/mL. In comparison, commercially available samples of Bakers yeast, laminarinase and laminarin were found (using the same detection method) to have concentrations of endotoxin of approximately 5 EU/mL (Bakers yeast) and less than 10 EU/mL (laminarinase and laminarin).

To verify the Pyrogene data and confirm that the glucan product of the present invention is substantially free of endotoxin, the level of TNF-α release from peripheral blood cluster differentiation (CD14+) monocytes (MPB-M cells) was measured using a TNF-α bioassay.

Cryopreserved MPB-M cells (LONZA) were placed in a 37° C. water bath and gently swirled until just thawed. The cells were mixed with 9 mL of MØ Medium-10% FBS (50 mL FBS, 5.0 mL 200 mM L-Glutamine, 450 mL RPMI 1640) and centrifuged at 210 RCF for 5 minutes at room temperature. Following centrifugation, the supernatant was aspirated and the cell pellet was resuspended in 5 mL of MØ Medium-10% FBS. A cell count was performed using Trypan Blue. The cells were seeded in 24 well plates at 5.0×10⁵ cells per well. GM-CSF and IL-6 were added to each well to make a final concentration of 10 ng/mL of each cytokine in order to induce differentiation of the monocytes into macrophages. The culture plates were incubated at 37° C. with 5% CO₂ for 7 days. The cultures were fed on day 3 or 4 as described above. On day 7, the non-adherent cells from the cultures were removed and the cultures were stimulated with 10 μg/mL glucan or 100 ng/mL endotoxin. Supernatants were harvested from each well at 24 hours post stimulation and immediately frozen at −30° C. for later analysis by ELISA. TNF-α levels were measured using ELISA kits obtained from R&D Systems, Inc. Macrophage culture supernatants were added to the ELISA plate. All ELISAs were performed according to the manufacturer's instructions.

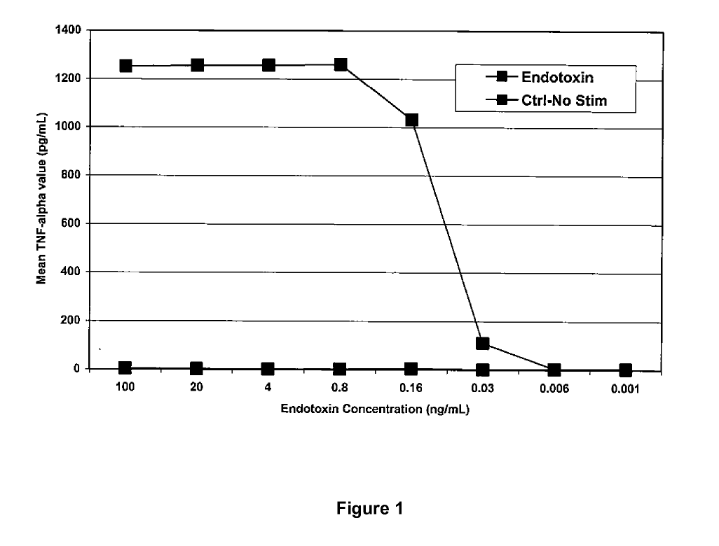

Endotoxin stimulates monocytes to release TNF-α, and this stimulation occurs at very low concentrations of endotoxin. An endotoxin dose response curve is shown in FIG. 1. It can be seen that even at endotoxin concentrations of 0.03 ng/mL, a TNF-α response of approximately 150 pg/mL was observed. There were 6 EU/ng endotoxin in the endotoxin sample assayed. Therefore, the bioassay effectively detected and responded to 0.18 EU of endotoxin at the 0.03 ng/mL dose. At a concentration of 100 ng/mL endotoxin, 1574 pg/mL TNF-α was detected.

In contrast, when TNF-α release was measured by ELISA following incubation of macrophages with 10 mg/mL glucan prepared in accordance with an embodiment of the invention, only 45 pg/mL TNF-α was detected. The concentration of 10 mg/mL glucan was chosen as it is sufficiently low to remove the effect of glucan-stimulated TNF-α.

From a reading of the description above in light of the appended drawings, it will be obvious to those with ordinary skill in the art that further modifications and changes may be made to the embodiments described herein without departing from the spirit and scope of the present invention as claimed.

1. A method for producing a glucan product substantially free of endotoxin contamination, said method comprising the step of washing the glucan with a halogentated solvent.

2. The method of claim 1, wherein the halogenated solvent is chloroform.

3. A method for producing a glucan product substantially free of endotoxin contamination, said method comprising the step of exposing the glucan to basic conditions.

4. The method of claim 3, wherein the basic conditions are conditions where the pH is between about 10 and about 14.

5. A method for producing a glucan product substantially free of endotoxin contamination, said method comprising the following steps:
(i) exposing the glucan to basic conditions;
(ii) washing the glucan with a chlorinated solvent; and
(iii) washing the glucan with an alcoholic solvent.

6. A method for producing a glucan product substantially free of endotoxin contamination, said method comprising the following steps:
(i) washing the glucan with a chlorinated solvent; and
(ii) subjecting the glucan to dry heat sterilization.

7. A method for producing a glucan product substantially free of endotoxin contamination, said method comprising the following steps:
(i) exposing the glucan to basic conditions; and
(ii) subjecting the glucan to dry heat sterilization.

8. The method of claim 6, wherein the dry heat sterilization involves heating the glucan to a temperature of between about 150° C. and 170° C.

9. A method for producing a glucan product substantially free of endotoxin contamination, said method comprising the following steps:
(i) exposing the glucan to basic conditions;
(ii) washing the glucan with an alcoholic solvent; and
(iii) subjecting the glucan to dry heat sterilization.

10. A method for producing a glucan product substantially free of endotoxin contamination, said method comprising the following steps:
(i) exposing the glucan to basic conditions;
(ii) washing the glucan with a chlorinated solvent; and
(iii) subjecting the glucan to dry heat sterilization.

11. A method for producing a glucan product substantially free of endotoxin contamination, said method comprising the following steps:
(i) washing the glucan with an alcoholic solvent; and
(ii) subjecting the glucan to dry heat sterilization.

12. A method for producing a glucan product substantially free of endotoxin contamination, said method comprising the following steps:
(i) washing the glucan with an alcoholic solvent;
(ii) washing the glucan with a chlorinated solvent; and
(iii) subjecting the glucan to dry heat sterilization.

13. A method for producing a glucan product substantially free of endotoxin contamination, said method comprising the following steps:
(i) exposing the glucan to basic conditions;
(ii) washing the glucan with an alcoholic solvent;
(iii) washing the glucan with a chlorinated solvent; and
(iv) subjecting the glucan to dry heat sterilization.

14. Glucan that is substantially free of endotoxin contamination, whenever obtained by the method of claim 1.

15. A composition comprising the glucan of claim 14, which is a therapeutic or health supplementary composition.

16. A method for the preparation of a therapeutic or health supplementary composition comprising using a glucan of claim 14.
